(19) United States
(12) Patent Application Publication
(10) Pub. No.: US 2018/0246196 A1
(43) Pub. Date: Aug. 30, 2018

(54) METHOD AND SYSTEM FOR ESTIMATING VEHICLE VELOCITY

(71) Applicant: Republic of Korea (National Forensic Service Director Ministry of Public Adm. and Security), Seoul (KR)

(72) Inventors: Jae Hyeong Lee, Chilgok-gun (KR); Young Nae Lee, Nam-gu (KR); Nam Kyu Park, Bucheon-si (KR); Jong Chan Park, Gimpo-si (KR); Jong Jin Park, Wonju-si (KR)

(21) Appl. No.: 15/905,303

(22) Filed: Feb. 26, 2018

(30) Foreign Application Priority Data
Feb. 27, 2017 (KR) 10-2017-0025652

(51) Int. Cl. G01S 11/14; G07C 5/00; G06F 17/14; G01S 11/12; G01H 3/06

(52) U.S. Cl. CPC G01S 11/14; G07C 5/008; G01H 3/06; G01S 11/12; G06F 17/142

(57) ABSTRACT

Provided is a method of estimating velocity of a vehicle, in which at least one black box is installed, the method including: receiving acoustic information from the black box, the acoustic information being synchronized with time of a certain image; transforming the acoustic information of a time domain to frequency data of a frequency domain via fast Fourier transformation (FFT); calculating revolutions per minute (RPM) of a main engine from the frequency data by using order analysis; and calculating velocity of the vehicle at the time of the certain image by using the RPM of the main engine and vehicle information.

### CROSS-REFERENCE TO RELATED APPLICATION

This application claims the benefit of Korean Patent Application No. 10-2017-0025652, filed on Feb. 27, 2017, in the Korean Intellectual Property Office, the disclosure of which is incorporated herein in its entirety by reference.

### BACKGROUND

### 1. Field

One or more embodiments relate to a method and system for estimating velocity of a vehicle by receiving acoustic information from a sound sensing device mounted in the vehicle.

### 2. Description of the Related Art

Vehicles are widely used transport units in modern life, and distribution of vehicles has spread to an extent that almost every household has a vehicle. There may be various accidents that a vehicle may go through, and it is important to find out an exact cause of an accident because problems frequently occur when parties of the accident claim differently about the cause of the accident. In particular, an instantaneous velocity at the moment of a car accident is one of important elements in analyzing the cause of the accident.

However, it is difficult to store vehicle velocity at every moment. In addition, although the velocity may be estimated by using image information of a black box that is an accident detection device, it is difficult to analyze instantaneous velocity at the moment of accident, because the black box captures images with a constant time interval and thus it is difficult to obtain detailed driving information at a moment of car crashing or because the vehicle suddenly reduces its speed right before the accident.

### SUMMARY

One or more embodiments include a method and system for estimating velocity of a vehicle by using acoustic information stored by a sound detection device mounted in a vehicle in real-time.

Additional aspects will be set forth in part in the description which follows and, in part, will be apparent from the description, or may be learned by practice of the presented embodiments.

According to one or more embodiments, a method of estimating velocity of a vehicle, in which at least one black box is installed, the method include: receiving acoustic information from the black box, the acoustic information being synchronized with time of a certain image; transforming the acoustic information of a time domain to frequency data of a frequency domain via fast Fourier transformation (FFT); calculating revolution per minute (RPM) of a main engine from the frequency data by using order analysis; and calculating velocity of the vehicle at the time of the certain image by using the RPM of the main engine and vehicle information.

The calculating of the RPM of the main engine may include determining a primary order of the main engine of the vehicle by using a number of cylinders of the main engine included in the vehicle information, and calculating the RPM of the main engine from the frequency data corresponding to the primary order.

The vehicle information may include a gear ratio of the vehicle, a final gear ratio of a differential gear, a size of a tire, and the number of cylinders of the main engine.

The calculating of the velocity of the vehicle may include: calculating an angular velocity of a transmission by using the RPM of the main engine and the gear ratio of the vehicle; calculating a rotational velocity of the tire by using the angular velocity of the transmission and the final gear ratio of the differential gear; and calculating the velocity of the vehicle by using the rotational velocity of the tire and the size of the tire.

The calculating of the velocity of the vehicle may include calculating an average velocity at the certain image time by using the certain image time and a travel distance corresponding to the certain image time from the black box, and estimating a gear step of the vehicle corresponding to the certain image time from the average velocity to calculate the gear ratio of the vehicle.

According to one or more embodiments, a device for estimating velocity of a vehicle by using a black box installed in the vehicle, the device include: a transformer configured to receive acoustic information from the black box, the acoustic information being synchronized with time of a certain image, and to transform the acoustic information of a time domain into frequency data of a frequency domain by fast Fourier transformation (FFT); and a velocity estimator configured to calculate revolution per minute (RPM) of a main engine from the frequency data by using order analysis, and to calculate velocity of the vehicle by using the RPM of the main engine and vehicle information.

The velocity estimator may be further configured to determine a primary order of the main engine of the vehicle by using a number of cylinders of the main engine included in the vehicle information, and to calculate the RPM of the main engine from the frequency data corresponding to the primary order.

The vehicle information may include a gear ratio corresponding to each gear step of the vehicle, a final gear ratio of a differential gear, a size of a tire, and the number of cylinders of the main engine.

The velocity estimator may be configured to calculate an angular velocity of a transmission by using the RPM of the main engine and the gear ratio of the vehicle, to calculate a rotational velocity of the tire by using the angular velocity of the transmission and the final gear ratio of the differential gear, and to calculate the velocity of the vehicle by using the rotational velocity of the tire and the size of the tire.

The device may further include a gear step estimator configured to calculate an average velocity at the time of the certain image by using the time of the certain image and a travel distance corresponding to the time of the certain image from the black box, and to estimate a gear step of the vehicle corresponding to the time of the certain image from the average velocity, wherein the velocity estimator may be configured to calculate the velocity of the vehicle by using the gear ratio of the vehicle, the gear ratio corresponding to the gear step that is estimated.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic conceptional diagram of a velocity estimation device of a vehicle according to an embodiment;

FIG. 2 is a block diagram of the velocity estimation device of FIG. 1;

FIG. 3 is a flowchart illustrating a method of estimating velocity of a vehicle by using the velocity estimation device of FIG. 1;

FIGS. 4A to 4C are diagrams illustrating an example of estimating an average velocity of a vehicle by using image information of a black box;

FIG. 5 is a spectrogram illustrating acoustic information obtained from the black box in an event of FIG. 4; and

FIG. 6 is a graph showing velocity estimated by a velocity estimation method according to an embodiment, with respect to the event of FIG. 4.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

As the present disclosure allows for various changes and numerous embodiments, particular embodiments will be illustrated in the drawings and described in detail in the written description. The attached drawings for illustrating one or more embodiments are referred to in order to gain a sufficient understanding, the merits thereof, and the objectives accomplished by the implementation. However, the embodiments may have different forms and should not be construed as being limited to the descriptions set forth herein.

The exemplary embodiments will be described below in more detail with reference to the accompanying drawings. Those components that are the same or are in correspondence are rendered the same reference numeral regardless of the figure number, and redundant explanations are omitted.

While such terms as “first,” “second,” etc., may be used to describe various components, such components must not be limited to the above terms. The above terms are used only to distinguish one component from another.

An expression used in the singular encompasses the expression of the plural, unless it has a clearly different meaning in the context.

In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

It will be understood that when a layer, region, or component is referred to as being “formed on” another layer, region, or component, it can be directly or indirectly formed on the other layer, region, or component. That is, for example, intervening layers, regions, or components may be present.

Sizes of components in the drawings may be exaggerated for convenience of explanation. In other words, since sizes and thicknesses of components in the drawings are arbitrarily illustrated for convenience of explanation, the following embodiments are not limited thereto.

When a certain embodiment may be implemented differently, a specific process order may be performed differently from the described order. For example, two consecutively described processes may be performed substantially at the same time or performed in an order opposite to the described order.

In the embodiments below, it will be understood when layers, areas, or elements or the like are referred to as being “connected,” they can be directly connected or an intervening portion may be present between layers, areas or elements. For example, when layers, areas, or elements or the like are referred to as being “electrically connected,” they can be directly electrically connected, or layers, areas or elements may be indirectly electrically connected and an intervening portion may be present.

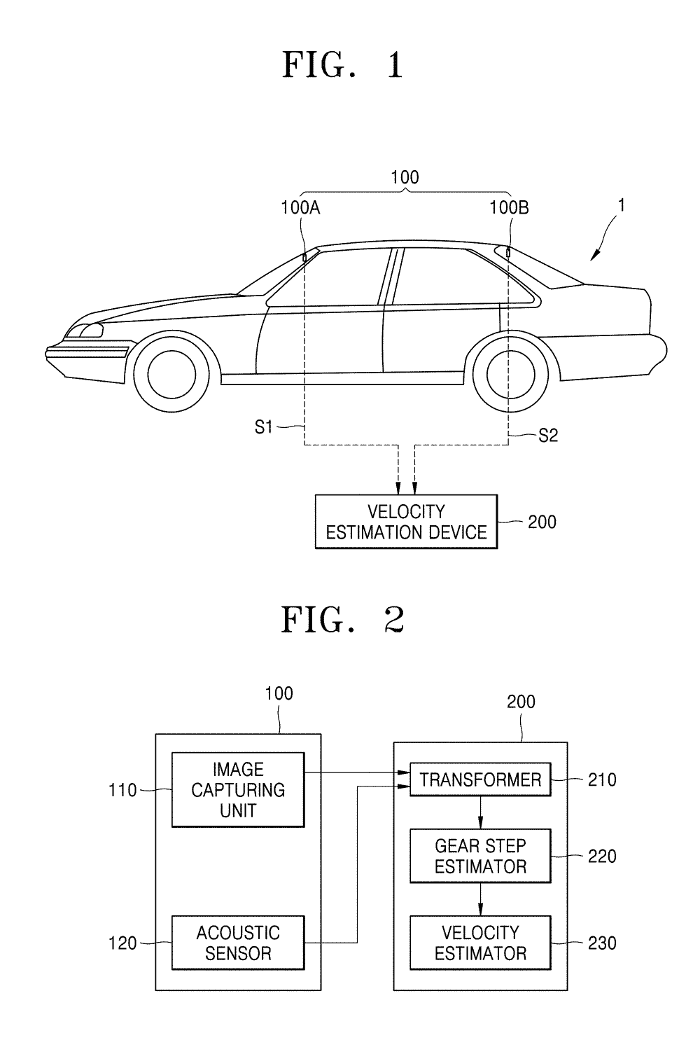

FIG. 1 is a schematic conceptional diagram of a speed estimation device 200 of a vehicle according to an embodiment, and FIG. 2 is a block diagram of the speed estimation device 200 of FIG. 1.

Referring to FIGS. 1 and 2, the speed estimation device 200 of a vehicle according to an embodiment includes a transformer 210 and a velocity estimator 230, and may further include a gear step estimator 220.

The transformer 210 may receive acoustic information synchronized with time of a certain image from a black box 100. Here, one or more black boxes 100 may be mounted in a vehicle 1, and the black box 100 may include an image capturing unit 110 that captures and stores images during driving of the vehicle 1 with a predetermined time interval, and an acoustic sensor 120 that senses sound during the driving of the vehicle 1 and generates acoustic information. As an embodiment, the black box 100 may include a first black box 100A arranged adjacent to a front of the vehicle 1 to monitor a front portion of the vehicle 1, and a second black box 100B arranged adjacent to a rear portion of the vehicle 1 to monitor back of the vehicle 1. However, the present disclosure is not limited thereto, and if necessary, only one black box may be mounted in the vehicle 1 or three or more black boxes may be mounted in the vehicle 1. The transformer 210 may receive acoustic information synchronized with time of a certain image, wherein the certain image denotes an image during a section, in which velocity of the vehicle 1 is to be measured, from among images stored in the image capturing unit 110 and may include an image at a moment of an accident of the vehicle 1.

In addition, the velocity of the vehicle 1 may be estimated by using image information of the black box 100. When the velocity of the vehicle 1 is estimated by using the image information from the black box 100, the image capturing unit 110 of the black box 100 may measure a travel distance on a map via first image information and second image information adjacent to a moment of accident. Here, an average velocity between the first image information and the second image information may be estimated by using a time period between the first image information and the second image information and the travel distance. However, since the image capturing unit 110 of the black box 100 captures images with a predetermined time interval, it is difficult to estimate instantaneous velocity at the moment of accident. One or more embodiments of the present disclosure provide the velocity estimation device 200 of the vehicle 1 capable of estimating instantaneous velocity at a moment of an accident and a velocity estimation method using the velocity estimation device 200.

The transformer 210 receives acoustic information synchronized with time of a certain image, in which the velocity is to be estimated, from the black box 100, and transforms the acoustic information of a time domain into frequency data of a frequency domain through fast Fourier transformation (FFT). The FFT is an algorithm designed to reduce the number of operations when performing discrete Fourier transformation by using an approximate formula based on Fourier transformation. By using the FFT, the acoustic information of the time domain may be transformed into frequency data of the frequency domain.

The velocity estimator 230 calculates revolution per minute (RPM) of a main engine by using order analysis, and calculates velocity of the vehicle 1 by using the calculated RPM of the main engine and vehicle information of the vehicle 1. Here, the vehicle information may include a gear ratio corresponding to each gear step of the vehicle 1, a final gear ratio of a differential gear, a tire size, and the number of cylinders in an engine. The vehicle information of the vehicle 1 may be stored in advance, or vehicle information searched for from outside may be used, if necessary. The velocity estimator 230 determines a primary order of the main engine of the vehicle 1 by using the number of cylinders in the vehicle information, and calculates RPM of the main engine from the frequency data corresponding to the primary order.

In addition, as another embodiment of the present disclosure, the velocity estimation device 200 of the vehicle 1 may further include the gear step estimator 220. The velocity estimation device 200 of the vehicle 1 according to the embodiment may estimate the gear step by using the frequency data with respect to a section in which the velocity varies, but it may be difficult to estimate the gear step only by using the frequency data with respect to a section of constant velocity. The velocity estimation device 200 of the vehicle 1 according to another embodiment may further include the gear step estimator 220 to estimate the gear step of the vehicle 1 corresponding to the time of a certain image. In detail, the gear step estimator 220 calculates an average velocity at the time of a certain image by using the time of a certain image, the velocity of which is desired to be identified, from the black box 100 and the travel distance corresponding to the time of a certain image, and may estimate the gear step of the vehicle 1 corresponding to the time of a certain image based on the calculated average velocity.

The velocity estimator 230 may calculate the velocity of the vehicle by using the gear ratio of the vehicle 1, which corresponds to the estimated gear step of the vehicle 1.

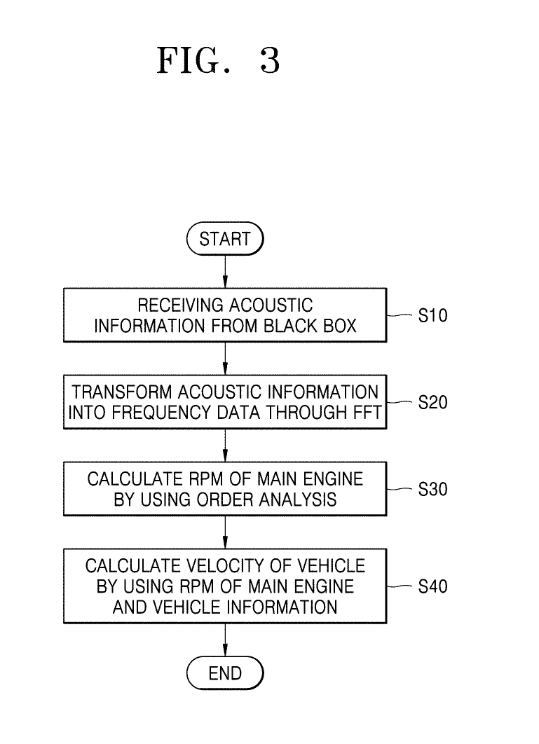

Hereinafter, a method of estimating velocity of the vehicle 1 by using the velocity estimation device 200 of the vehicle 1 will be described below with reference to FIG. 3.

FIG. 3 is a flowchart illustrating a method of estimating velocity of a vehicle by using the velocity estimation device 200 of FIG. 1.

Referring to FIG. 3, according to the method of estimating velocity of the vehicle in which at least one black box is mounted, the velocity estimation device 200 of the vehicle receives acoustic information synchronized with time of a certain image from the black box (S10). As described above, the black box captures images with a predetermined time interval and continuously senses sound during driving to generate the acoustic information. The speed estimation device 200 allows a user to identify images adjacent to or images before and after an accident based on a moment of the accident, and extracts acoustic information corresponding to the images to use the acoustic information in the speed estimation method. Since the acoustic information is continuously sensed and stored, unlike the image information that is captured and stored with a predetermined time interval, instantaneous velocity of the vehicle 1 may be estimated by using the acoustic information. In addition, when a plurality of black boxes are mounted in the vehicle 1, for example, when first acoustic information 51 and second acoustic information S2 are provided respectively from a first black box 100A and a second black box 1008, the velocity of the vehicle 1 may be estimated by using an average value of the first acoustic information 51 and the second acoustic information S2.

Next, acoustic information of the time domain is transformed into frequency data of the frequency domain via FFT (S20). After that, RPM of the main engine is calculated from the frequency data based on order analysis (S30). The calculating of RPM of the main engine may include determining a primary order of the main engine of the vehicle 1 by using the number of cylinders in the vehicle information, and calculating RPM of the main engine from the frequency data corresponding to the primary order. In general, a vehicle includes various mechanical systems, as well as the engine, and thus, frequencies of various orders may be generated. Here, frequency data of acoustic information generated by one engine cylinder may correspond to 0.5th order. For example, in a case of a vehicle including four-stroke and four-cylinder engine, second order that is four times greater than 0.5 may be a primary order, and in a case of a vehicle including six-cylinder engine, third order may be a primary order. The primary order is determined based on the vehicle information, and RPM of the main engine may be calculated from frequency data F₀ corresponding to the primary order by using Equation 1 below.

RPM of main engine=F₀/p×[60×2]

Here, F₀ is frequency data corresponding to the primary order, and p denotes poles of the engine.

Next, an angular velocity of a transmission is calculated by using the calculated RPM of the main engine and the gear ratio of the vehicle 1, and rotational velocity of a tire installed on the vehicle 1 is calculated by using the angular velocity of the transmission and the final gear ratio of the differential gear. After that, the velocity of the vehicle 1 may be calculated by using the rotational velocity of the tire and a radius of the tire. The above process may be expressed by Equation 2 below.

$$velocity of vehicle = \frac{RPM of main engine}{gear ratio of each gear step \times final gear ratio} \times π \times R \times 60$$

Here, R denotes a diameter (mm) of the tire mounted on the vehicle 1 and is calculated by Equation 3 below.

$$R = ( \frac{width of tire \times flatness ratio}{100} ) \times 2 + ( wheel inches \times 25.4 )$$

The gear ratio of each gear, the final gear ratio, and the tire size of the vehicle 1 may be acknowledge in advance, or may be searched for, if necessary. Here, the gear step of the vehicle 1 may be estimated by using the frequency data in a section where the velocity changes. However, it is difficult to estimate the gear step only by using the frequency data in a section where the velocity is constant. Therefore, the gear step of the vehicle 1, which corresponds to the time of a certain image, may be estimated by calculating an average velocity at the time of the certain image by using the time of the certain image from the black box and the travel distance corresponding to the time of the certain image. The gear ratio in Equation 2 above may correspond to the estimated gear step of the vehicle 1.

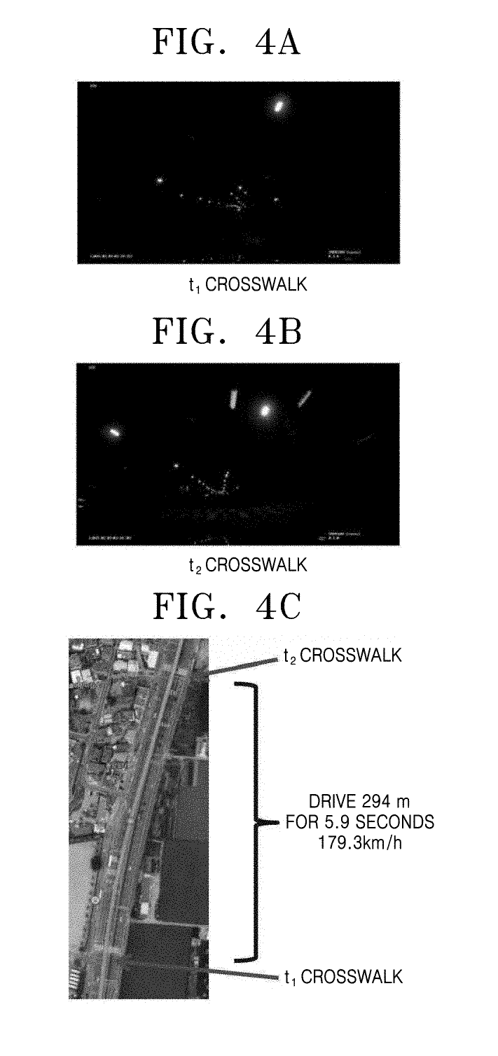

FIGS. 4A to 4C are diagrams illustrating an example of estimating an average velocity of a vehicle by using image information of a black box.

Referring to FIG. 4, according to a comparative example in which the velocity is estimated by using the image information of the black box, time information may be obtained from a certain image, from which the velocity is to be estimated. FIG. 4A is a black box image at a first time t₁ at a first crosswalk, and FIG. 4B is a black box image at a second time t₂ at a second crosswalk. Here, the first time t₁ is 2.435 seconds and the second time t₂ is 8.313 seconds, and as shown in FIG. 4C, a distance between the first crosswalk and the second crosswalk on a map is 294 m and an average velocity may be 179.3 km/h.

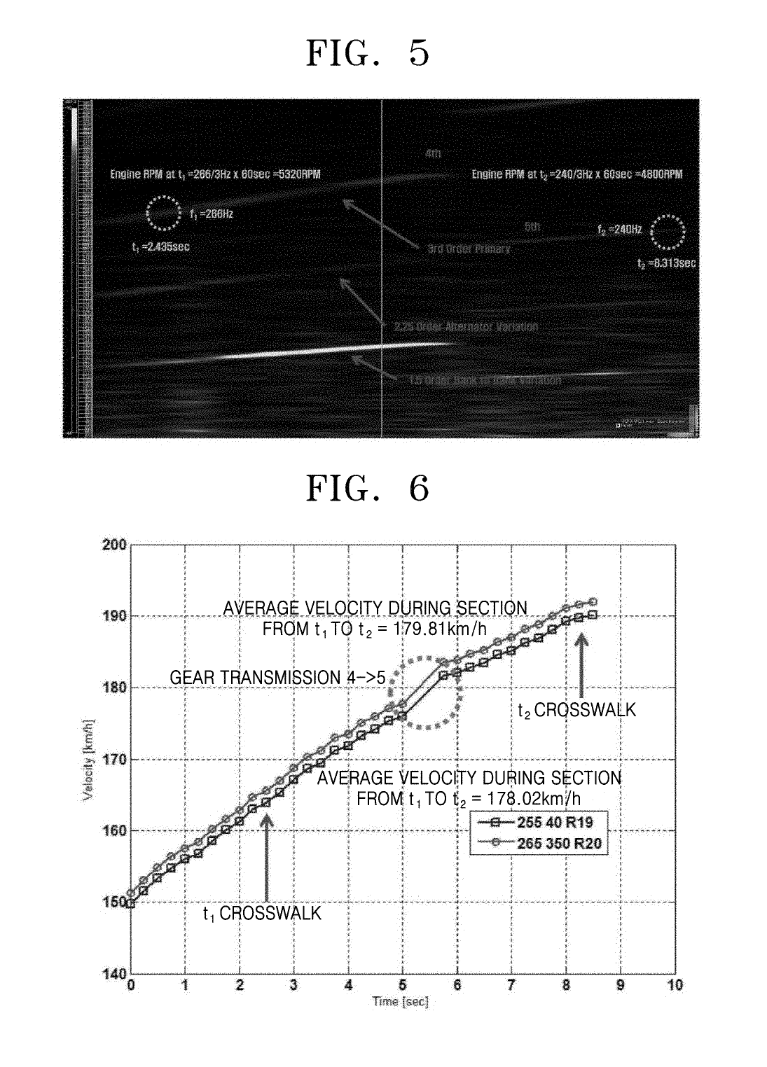

FIG. 5 is a spectrogram showing acoustic information obtained from the black box in the event shown in FIG. 4A to 4C, and FIG. 6 is a graph of an estimated velocity that is estimated by the velocity estimation method according to an embodiment in the event shown in FIG. 4A to 4C.

Referring to FIGS. 5 and 6, in the method of estimating velocity of a vehicle according to an embodiment, acoustic information from the first time t1 to the second time t2 is provided from the black box, and the velocity of the vehicle may be calculated by using vehicle information, e.g., the number of cylinders of the engine, a final gear ratio, a gear ratio of each gear step of the vehicle, and a tire size. Here, model name of the vehicle may be Audi A7 3.0 TDI, and the tire may be provided in two sizes, that is, 255 40 R19 and 265 350 R20. In this case, the vehicle has a six-cylinder engine, and the primary order is third order. Therefore, in the method of estimating the velocity of the vehicle according to the embodiment, an instantaneous velocity at each time point may be estimated by using the frequency data corresponding to the third order, and may be represented in the graph of FIG. 6 showing velocity versus time. The average velocity between the first time t₁ and the second time t₂ estimated according to the method of the present embodiment may be 179.81 km/h and 178.052 km/h according to the tire sizes, which are not much different from the average velocity estimated by using the image information of the black box.

As described above, according to the velocity estimation device of a vehicle and the method of estimating velocity of the vehicle using the velocity estimation device of the embodiments, the instantaneous velocity of the vehicle corresponding to time of a certain image such as a moment of accident may be estimated by using the acoustic information of the black box, and thus, a cause of the car accident may be exactly analyzed.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A method of estimating velocity of a vehicle, in which at least one black box is installed, the method comprising:
receiving acoustic information from the black box, the acoustic information being synchronized with time of a certain image;
transforming the acoustic information of a time domain to frequency data of a frequency domain via fast Fourier transformation (FFT);
calculating revolution per minute (RPM) of a main engine from the frequency data by using order analysis; and
calculating velocity of the vehicle at the time of the certain image by using the RPM of the main engine and vehicle information.

2. The method of claim 1, wherein the calculating of the RPM of the main engine comprises determining a primary order of the main engine of the vehicle by using a number of cylinders of the main engine included in the vehicle information, and calculating the RPM of the main engine from the frequency data corresponding to the primary order.

3. The method of claim 1, wherein the vehicle information includes a gear ratio of the vehicle, a final gear ratio of a differential gear, a size of a tire, and the number of cylinders of the main engine.

4. The method of claim 3, wherein the calculating of the velocity of the vehicle comprises:
calculating an angular velocity of a transmission by using the RPM of the main engine and the gear ratio of the vehicle;
calculating a rotational velocity of the tire by using the angular velocity of the transmission and the final gear ratio of the differential gear; and
calculating the velocity of the vehicle by using the rotational velocity of the tire and the size of the tire.

5. The method of claim 3, wherein the calculating of the velocity of the vehicle comprises calculating an average velocity at the certain image time by using the certain image time and a travel distance corresponding to the certain image time from the black box, and estimating a gear step of the vehicle corresponding to the certain image time from the average velocity to calculate the gear ratio of the vehicle.

6. A device for estimating velocity of a vehicle by using a black box installed in the vehicle, the device comprising:
a transformer configured to receive acoustic information from the black box, the acoustic information being synchronized with time of a certain image, and to transform the acoustic information of a time domain into frequency data of a frequency domain by fast Fourier transformation (FFT); and
a velocity estimator configured to calculate revolution per minute (RPM) of a main engine from the frequency data by using order analysis, and to calculate velocity of the vehicle by using the RPM of the main engine and vehicle information.

7. The device of claim 6, wherein the velocity estimator is further configured to determine a primary order of the main engine of the vehicle by using a number of cylinders of the main engine included in the vehicle information, and to calculate the RPM of the main engine from the frequency data corresponding to the primary order.

8. The device of claim 6, wherein the vehicle information includes a gear ratio corresponding to each gear step of the vehicle, a final gear ratio of a differential gear, a size of a tire, and the number of cylinders of the main engine.

9. The device of claim 8, wherein the velocity estimator is configured to calculate an angular velocity of a transmission by using the RPM of the main engine and the gear ratio of the vehicle, to calculate a rotational velocity of the tire by using the angular velocity of the transmission and the final gear ratio of the differential gear, and to calculate the velocity of the vehicle by using the rotational velocity of the tire and the size of the tire.

10. The device of claim 8, further comprising a gear step estimator configured to calculate an average velocity at the time of the certain image by using the time of the certain image and a travel distance corresponding to the time of the certain image from the black box, and to estimate a gear step of the vehicle corresponding to the time of the certain image from the average velocity,
wherein the velocity estimator is configured to calculate the velocity of the vehicle by using the gear ratio of the vehicle, the gear ratio corresponding to the gear step that is estimated.
